(19) United States
(12) Patent Application Publication
(10) Pub. No.: US 2020/0244212 A1
(43) Pub. Date: Jul. 30, 2020

(54) APPARATUSES AND METHODS TO STRENGTHEN MOUNTED SOLAR PANELS

(71) Applicant: BRIGHTSPOT AUTOMATION LLC, Westford, MA (US)

(72) Inventors: Andrew M. GABOR, Providence, RI (US); Andrew P. ANSELMO, Arlington, MA (US); Robert E. JANOCH, JR., Westford, MA (US)

(21) Appl. No.: 16/775,614

(22) Filed: Jan. 29, 2020

Related U.S. Application Data
(60) Provisional application No. 62/798,521, filed on Jan. 30, 2019.

(51) Int. Cl. H02S 20/23; H02S 30/10

(52) U.S. Cl. CPC H02S 20/23; H02S 30/10

(57) ABSTRACT

Apparatus and methods to mount solar panels in a way that the panels are supported from the rear side by spacer elements termed RailPads and RoofPads are provided. These spacer elements press upon the rear side of the panel to displace regions of the panel away from the mounting structure. The support provided by the spacer elements reduces downward panel deflection from wind, snow, and other loads, thus minimizing tensile stress in the cells and thus minimizing solar cell crack formation and propagation. The upward bow in the panel places cells in a state of protective compressive stress.

### RELATED APPLICATIONS

This application claims the benefit of priority to U.S. Provisional Patent Application No. 62/798,521 entitled “Method to strengthen mounted solar panels” filed Jan. 30, 2019, the entire contents of which are incorporated herein by reference.

### FIELD OF THE INVENTION

The present invention is directed to apparatuses and methods to prevent power loss from cracked cells in solar panels.

### BACKGROUND OF THE INVENTION

The most common solar panel design utilizing a front glass coversheet and a polymer backsheet with copper interconnect wires between silicon cells is sensitive to the tensile stress related cracking of the cells when front side mechanical loads are applied to the panel through handling, snow load, or wind load. In spite of training, installation workers and Operations & Maintenance workers are also known to commonly walk on panels, and this pressure is also sufficient to crack cells. These cracks are often closed initially after formation with minimal power loss, but over time the cracks can open up such that metallization is discontinuous across the cracks, leading to higher than desired degradation rates and risks of hot spot heating. Several trends within the industry are helping to reduce the occurrence of such cracks, for example by using glass backsheets to place the cells in the neutral plane mechanically so that cells are not placed into tensile stress under load, or by using interconnect methods using electrically conductive adhesives to eliminate solder induced damage in the silicon, such as in shingled panels. Should cracks occur, the trend of using a higher number of interconnect wires on each cell reduces the potential power losses. Still other trends are adding to crack related risks such as reduced frame mass that allows module to bend more with applied loads, larger modules with center regions that are farther from the frame, thicker interconnect wires to carry the steadily increasing amounts of cell current which then cause more soldering induced microcracks in the silicon, and half-cut cells or even narrower shingled cells which have weak laser-cut edges from which cracks are more likely to propagate. In addition, a large installed base of panels exist which are more sensitive to cells cracking with only 2 or 3 busbars, and which already have a high density of cells cracks or which are sensitive to their formation in the future.

One feature seen in an increasing number of panels is an aluminum (Al) cross bar spanning the width on the rear side of panel and connected to the extruded Al frame on each side with screws. This stiffens the solar panel and effectively reduces the deflection (and thus tensile stress) vs load. Some of these panels even have a pad in the middle that lightly touches the backsheet or has a narrow air gap, and such a pad can further reduce panel deflection vs load. However, they have no effect on the panel other than when the front side pressure is being applied. In the inventors' experience, these lightweight, extruded Al bars have a limited effectiveness in reducing deflection vs load, and that the bars become permanently deformed at front side loads >3000 pascal (Pa)—well below the heavy snow load condition of 5400 Pa.

Panels in the field are most commonly attached with clamps or bolts to two metal rails that span the full width or length of the panel. Most commonly the rails extend across the short dimension of the panel (−1 meter wide) and intersect the long edges at the ⅕ and ⅘ points from one of the corners. A typical frame thickness is ˜35 millimeters (mm) with a lip or flange that touches the rails. Given a laminate thickness of ˜4.5 mm, this leaves a gap of over 30 mm between the backsheet and the rails. Some researchers have reported that at heavy snow load conditions, the modules can deflect this full gap distance and even touch the rails, but with such a high level of deflection, usually significant cell cracking will have occurred. On residential rooftops, panels may be fixed to point clamping elements rather than rails, leaving an even larger gap underneath the panel over which it can deform under front side loads.

Looking forward, the industry could benefit from more choices in improved panels designs and manufacturing methods where either the cells are less likely to crack in the first place, or if they do, the cracks are less likely to contribute to power loss. The industry could also benefit from methods to extend the lifetime of the already installed base of panels sensitive to crack related degradation.

### SUMMARY

The invention relates to apparatus and methods to mount solar panels in a way that the panels are supported from the rear side by spacer elements termed RailPads and RoofPads. These spacer elements press upon the rear side of the panel to displace regions of the panel away from the mounting structure. The support provided by the spacer elements reduces downward panel deflection from wind, snow, and other loads, thus minimizing tensile stress in the cells and thus minimizing solar cell crack formation and propagation. The upward bow in the panel places cells in a state of protective compressive stress. In a tensile stress state, there are forces being applied to the cells which are stretching them outward along the plane of the cells, as if there were a clamp along each edge of the cells pulling each edge away from the center. A small crack defect can be stretched apart so that it propagates into a long crack due to such forces. The opposite is true for cells in a state of compressive stress. Here there are forces being applied to the cells which are pushing inward along the plane of the cells, as if there were a clamp along each edge of the cells pushing inward toward the center. Any short crack defect will be pressed closed by such forces such that is less likely to propagate. Even when front side loads are applied to the solar panel, the loads may need to be very high for the stress levels to switch from compression to tension for many cells in the panel.

The invention relates to methods of making and installing spacer elements that limit the inward deflection of photovoltaic solar panels when front side mechanical loads are applied. By limiting bending of the panels, the silicon solar cells within the panels are prevented from seeing the high tensile stresses that accompany such bending, and thus they are less likely to form cracks that can degrade panel performance. Additionally, limiting the deflection can allow any cracks that are present in the solar cells to more likely remain in a tightly closed state that does not contribute to power loss. Additionally, by choosing spacer elements that force a small outward deflection of the panel surface, the cells can be kept in a protective state of compressive stress so that new cracks are even more unlikely to form, and if cracks are present, that they will be more likely to remain in a tightly closed state.

Various embodiments may provide a photovoltaic solar panel mounting system, comprising one or more spacer elements, wherein the one or more spacer elements are configured to be positioned between a rear side of a solar panel and one or more mounting rails supporting the solar panel such that, when the one or more spacer elements are so positioned, a face of the solar panel is deflected from a neutral position away from the one or more mounting rails after two or more clamps attach the solar panel to the one or more mounting rails.

Various embodiments may provide a rooftop photovoltaic solar panel mounting system, comprising one or more spacer elements, wherein the one or more spacer elements are configured to be positioned between a rear side of a solar panel and a rooftop surface such that a face of the solar panel is deflected from a neutral position away from the rooftop surface after two or more clamps attach the solar panel to one or more mounting elements fixed to the rooftop surface.

Various embodiments may provide a method for mounting a photovoltaic solar panel, the method comprising positioning one or more spacer elements between a rear side of a solar panel and a mounting surface such that a face of the solar panel is deflected from a neutral position in a direction outward from the mounting surface after attachment of the solar panel to the mounting surface.

### BRIEF DESCRIPTION OF THE DRAWINGS

The accompanying drawings, which are incorporated herein and constitute part of this specification, illustrate example aspects of the claims, and together with the general description given above and the detailed description given below, serve to explain the features of the claims.

FIG. 1a shows the front side view of a solar panel with standard mounting on two rails traversing the width of the panel.

FIG. 1b shows the cross-section view of the mounted panel along the axis of one of the rails.

FIG. 1c shows the cross-section view of this mounted panel of FIG. 1a along the axis perpendicular to the rails.

FIG. 2a shows the cross-section view of the mounted panel along the axis of one of the rails as in FIG. 1b but in this case with a front load applied to the panel, causing it to deflect in the middle.

FIG. 2b shows the cross-section view of the mounted panel along the axis perpendicular to the rails as in FIG. 1c but in this case with a front load applied to the panel, causing it to deflect in the middle.

FIG. 3a shows the cross-section view of a mounted and loaded panel along the axis of one of the rails as in FIG. 2a, but in this case with a RailPad assembly.

FIG. 3b shows the cross-section view of this mounted and loaded panel with RailPads as in FIG. 3a but along the axis perpendicular to the rails.

FIG. 4 shows the cross-section view of a mounted panel along the axis of one of the rails as in FIG. 3c, but in this case rather than using a single long RailPad assembly, there are 3 shorter RailPad assemblies.

FIG. 5a shows the front side view of a solar panel with 4-point mounting on 4 short rails at the corners of the panel as might be employed on a residential rooftop.

FIG. 5b shows the top view of the solar panel with 4-point mounting shown in FIG. 5a .

FIG. 6a shows the front side view of a solar panel with 4-point mounting on 4 short rails at the corners of the panel as might be employed on a residential rooftop, similar to FIG. 5a except that in this case, a RoofPad in the center of the panel supports the panel to minimize deflection under load.

FIG. 6b shows the top view of a rooftop with 4-point mounting fixtures and a RoofPad in place, as is shown in FIG. 6a, but in this case without the panel in place.

FIG. 7a shows a RailPad formed from bent sheet metal and elastomer suitable for use in a new construction with a rail having wide slot.

FIG. 7b shows the RailPad from FIG. 7a after insertion into the slot of a rail.

FIG. 8a shows a RailPad suitable for use on a tracker system with a single central rail tube, or on a ground mount system with two rails.

FIG. 8b shows the RailPad from FIG. 8a after insertion of the RailPad between a solar panel and a rail.

FIG. 8c shows the RailPad from FIG. 8b after engagement of a cam to displace the laminate face away from the rail and after securing of the RailPad in place.

FIG. 9a shows a RailPad suitable for use on a tracker system where the bottom RailPad piece is first placed on the tracker rail tube, and a second RailPad piece is slid onto from the side.

FIG. 9b shows the RailPad from FIG. 9a after the laminate (not shown) has been lifted up to allow the second RailPad piece to be raised up and secured with a pin or bolt.

FIG. 10a shows bottom and top RailPad elements on a lightweight rail design common in residential installations.

FIG. 10b shows the RailPad elements from FIG. 10a after the top element has been slid on top of the bottom element such that the combined height is sufficient to push upward on a laminate.

FIG. 11a shows bottom and top RailPad elements on a lightweight rail design common in residential installations.

FIG. 11b shows the RailPad elements from FIG. 11a after the top element has been slid on top of the bottom element such that the combined height is sufficient to push upward on a laminate.

FIG. 11c shows the RailPad elements from FIG. 11b after a pin has been inserted into holes in each element to secure them together.

FIG. 12a shows bottom and top RailPad elements on a lightweight rail design common in residential installations.

FIG. 12b shows the RailPad elements from FIG. 12a after the top element has been slid on top of the bottom element such that the combined height is sufficient to push upward on a laminate.

FIG. 13a shows a RailPad that may be made out of a single piece of sheet metal, bent in such fashion that no extra elements are needed to install it.

FIG. 13b shows the RailPad from FIG. 13a after it has been placed on a rail and the triangular elements bent so as to increase the total thickness of the RailPad and cause the laminate (not shown) to be lifted up away from the rail.

FIG. 14a shows a RailPad suitable for use on a tracker system where the RailPad bottom element is first placed on the tracker rail tube, and a RailPad top element is placed on the tube to the side

FIG. 14b shows the RailPad from FIG. 14a after the RailPad top element has been slid on top of the bottom element, and a cam lifting element brought nearby.

FIG. 14c shows the RailPad from FIG. 14b after the cam has been inserted between the two RailPad elements, and a tool has rotated the cam to lift the top element upward to displace the laminate away from the rail.

FIG. 14d shows the RailPad from FIG. 14c together with the module after the cam action and bolt or pin fixing action are complete and the cam and tool removed.

FIG. 15a is a flow diagram illustrating a method for installing RailPads in a new installation where the solar panels have not yet been mounted on the rails in accordance with an embodiment of the invention utilizing the methods and equipment discussed in this application.

FIGS. 15b and 15c are a flow diagrams illustrating methods for installing RailPads in a retrofit installation where the solar panels have already been mounted on the rails in accordance with embodiments of the invention utilizing the methods and equipment discussed in this application.

FIG. 15d is a flow diagram illustrating a method for installing RoofPads in a new installation where the solar panels have not yet been mounted on the roof in accordance with an embodiment of the invention utilizing the methods and equipment discussed in this application.

FIG. 16 shows the displacement of the center rear point of a solar panel laminate vs time during a 2019 storm in FL for both a solar panel with two RailPads and for a solar panel with no RailPads where the displacement is far less with the RailPads.

FIG. 17a shows an embodiment RailPad that is an integral part of a mounting rail shown with a panel mounted on the rail.

FIG. 17b is a view of a portion the integral RailPad of FIG. 17a.

FIG. 17c is a view of a portion of the RailPad that is an integral part of a mounting rail of FIG. 17a without a panel mounted on the rail.

FIG. 17d is a view of the RailPad that is an integral part of a mounting rail of FIG. 17a without a panel mounted on the rail.

FIG. 18 shows another embodiment RailPad that is an integral part of a mounting rail shown with a panel mounted on the rail.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The following detailed description is merely illustrative in nature and is not intended to limit the embodiments the application and uses of such embodiments. As used herein, the word “exemplary” means “serving as an example, instance, or illustration.” Any implementation described herein as exemplary is not necessarily preferred or advantageous over other implementations. Furthermore, there is no intention to be bound by any expressed or implied theory presented in the preceding technical field, background, brief summary or the following detailed description.

References to “one embodiment” or “an embodiment” do not necessarily refer to the same embodiment. Particular features, structures, or characteristics can be combined in any suitable manner consistent with this disclosure.

Terminology. The following paragraphs provide definitions and/or context for terms found in this disclosure (including the appended claims):

“About” or “approximately”. As used herein, the terms “about” or “approximately” in reference to a recited numeric value, including for example, whole numbers, fractions, and/or percentages, generally indicates that the recited numeric value encompasses a range of numerical values (e.g., +/−5% to 10% of the recited value) that one of ordinary skill in the art would consider equivalent to the recited value (e.g., performing substantially the same function, acting in substantially the same way, and/or having substantially the same result).

“Comprising” is an open-ended term that does not foreclose additional structure or steps.

“First,” “second,” etc. terms are used as labels for nouns that they precede, and do not imply any type of ordering (e.g., spatial, temporal, logical, etc.). For example, reference to a “first” RailPad does not necessarily imply that this RailPad is the initial RailPad in a sequence; instead the term “first” may be used to differentiate this RailPad from another RailPad (e.g., a “second” RailPad).

The terms “a” and “an” are defined as one or more unless this disclosure explicitly requires otherwise.

As used herein, the term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” can be substituted with “within [a percentage] of” what is specified, where the percentage includes 0.1, 1, 5, and 10 percent.

As used herein, “regions” can be used to describe discrete areas, volumes, divisions or locations of an object or material having definable characteristics but not always fixed boundaries.

In addition, certain terminology can also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology can include the words specifically mentioned above, derivatives thereof, and words of similar import.

The term “laminate” refers to all portions of the solar panel other that the perimeter frame portion.

The terms “solar panel” and “module” are synonymous.

In the following description, numerous specific details are set forth, such as specific operations, in order to provide a thorough understanding of embodiments of the present disclosure. It will be apparent to one skilled in the art that embodiments of the present disclosure can be practiced without these specific details. In other instances, well-known techniques are not described in detail in order to not unnecessarily obscure embodiments of the present disclosure

In this work, we detail the design and implementation of spacer elements located behind a solar panel to limit panel deflection from front side loads and to place cells in a protective compressive stress state, and thereby reduce panel degradation from cracked solar cells. Two general embodiments are detailed, one where the RailPad spacer elements are support by the mounting rail(s) to which the solar panel is attached, and other where a flat surface such as a rooftop provides this support to the RoofPad spacer element(s). In a tensile stress state, there are forces being applied to the solar cells which are stretching them outward along the plane of the solar cells, as if there were a clamp along each edge of the solar cells pulling each edge away from the center. The opposite is true for solar cells in a state of compressive stress. In solar cells in a state of compressive stress there are forces being applied to the solar cells which are pushing inward along the plane of the solar cells, as if there were a clamp along each edge of the solar cells pushing inward toward the center. Even when front side loads are applied to the solar panel, the loads may need to be very high for the stress levels to switch from compression to tension for many solar cells in the panel.

In one embodiment of the present invention, a spacer element, termed by the inventors as a “RailPad,” is placed on the middle of each rail to eliminate the space between the backsheet of the solar panel and the rail such that when front side loads are applied, the average deflection of the panel is far lower than would be the case without the RailPad. With lower deflection levels, cell cracking will be greatly reduced, and/or mass can be removed from elsewhere in the panel to reduce costs and open up new markets for lighter weight panels. The RailPads could be attached to the rails either in the factory, in the field prior to installation, or added as a retrofit to pre-existing systems. The RailPads may be attached to the rails by press fitting, sliding into grooves, screwing or bolting down, welding, or by adhesive bonding. The RailPads could also be an inherent part of the rail, for example by sheet metal bending or deformation. In order to maximize the benefit, the RailPad thickness is chosen such that the RailPads press on the backsheet to deflect the face of the solar panel upward and place the cells under protective compressive stress. An additional benefit of pressing upward on the face of the solar panel relates to wind bursts that have the potential to rapidly bang the panel against the RailPads, potentially causing damage over time. If for example an air gap were to be left between the RailPad and the rear side of the solar panel, front side wind bursts could bang the rear side of the solar panel against the RailPads. In the case of mounting the rear side of the solar panel flush against the top surface of the RailPads, then rapidly changing rear side wind bursts could lift the panel outward and away from the RailPad surface, followed by a release of wind load or a reversal of wind load which then bangs the rear side of the solar panel against the RailPads. By preloading the rear side of the solar panel with the pressure from the RailPads, then some range of rear side wind bursts will be unable to lift the module away from the RailPad surface, thus eliminating completely some banging events. For stronger wind bursts that do manage to lift the module away from the RailPads, any subsequent banging will be lower in severity.

In order to prevent damage occurring in the interface region between the RailPads and the panel, the RailPads may have soft elastomeric top layer. A preferred embodiment of such an elastomer is silicone rubber which has excellent weathering properties. Other possible elastomers include, but are not limited to, ethylene propylene diene monomer (EPDM) rubber, butyl rubber, neoprene, and urethane. The majority of the thickness of the RailPads should be stiff to resist deflection, low-cost, and durable under decades of outdoor exposure such as extruded Al, steel, and hard plastics. In some embodiments, RailPads may be formed from a non-metal material, such as plastic. RailPads formed from non-metal materials may be advantageous in that the non-metal RailPads may not require grounding. In some embodiments, RailPads may be grounded to the rails to prevent the RailPads from being energized. The grounding of the RailPads may be achieved in any manner, such as by bonding washers, WEEB (Washer, Electrical Equipment Bonding) mounts, star washers, and/or flange nuts.

In another embodiment, the RailPad spacing element is attached to the backsheet of the solar panel in the locations directly opposite where the rails will be in order to accomplish the same goals as above. Again, as in the above embodiment, the RailPads could be attached to the panels either in the factory, in the field prior to installation, or added as a retrofit to pre-existing systems. Again, as in the above embodiment, the RailPad thickness is chosen such that under no front-side load, the RailPads press on the rail to deflect the glass and place the cells under protective compressive stress.

In some embodiments, the long axis of the RailPads are approximately colinear with the long axis of the rails onto which they are placed. In other embodiments, the long axis of the RailPads may be approximately perpendicular the long axis of the rails.

In some embodiments, the top surface of the RailPad is flat. In other embodiments the top surface is curved which may result in more uniform force applied to the rear side of the laminate or in a force profile that best protects the solar cells. In other embodiments even though the top surface of the RailPad is flat prior to installation, the RailPad may bend in a way such that it is curved after installation, for example if the long axis of the RailPad is oriented perpendicular to the supporting rail such that the rail supports the RailPad only near the center of the RailPad.

In some embodiments, the solar panels are implemented within a single-axis tracker installation where each solar panel is clamped to a single rail which rotates over the course of each day to keep the front face of the solar panels oriented toward the sun. This single rail, sometime termed a “tube” is often clamped to the frame of the solar panels near the middle of the long edge of the frames. By introducing a RailPad between this tracker rail tube and the rear side of a solar panel, as the tracker rail tube rotates, the relative positions of the solar panel rear surface, the RailPad, and the tracker rail tube remain constant and no stress is placed on the system. Some solar panels have features such as junction boxes, cables, and crossbars on the rear side in the middle region which might interfere with the placement of some RailPad embodiments. Alternative embodiments may be necessary in such cases to avoid this interference. For example, to avoid junction boxes and cables, a shorter single RailPad, multiple shorter RailPads, or RailPads with depressions or cutout regions could be implemented.

In some embodiments where no rails are used in mounting the panels to roofing structures, but rather the panels are attached to point clamping elements, a differently designed spacer element which the inventers term a “RoofPad” can be used to limit the panel deflection under front side loads. The RoofPads could be likewise be attached to the roof or to the panel during initial installation or added as a retrofit to pre-existing systems. The RoofPads may be attached to the roof by a variety of methods, including but not limited to screwing down, bolting down, or by bonding with adhesive. The RoofPad thickness is chosen such that under no front-side load, the RailPads press on the backsheet to deflect the glass and place the cells under protective compressive stress. As explained about for RailPads, there may be an undesireable range of gaps or deflection amounts where banging from wind could occur.

In some embodiments, the RailPad may be installed prior to installation of the solar panel. In such embodiments, the action of clamping the frame of the solar panel to the supporting structure will cause the deflection of the laminate to occur. In other embodiments, the RailPad may be installed after installation of the solar panels. In such embodiments, the deflection of the laminate may be enacted by pressing by hand or with a tool to make room for insertion of the RailPad, and upon release of this pressure, the laminate rests on the RailPad top surface. Alternatively, the deflection of the laminate may occur as a result of the RailPad insertion process, for example by pressing two parts together or by rotating a cam feature.

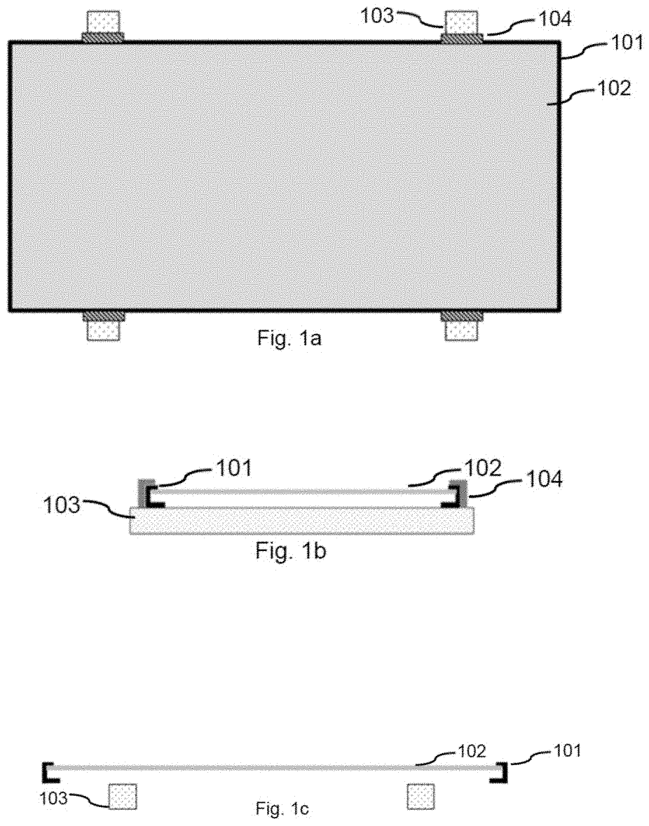

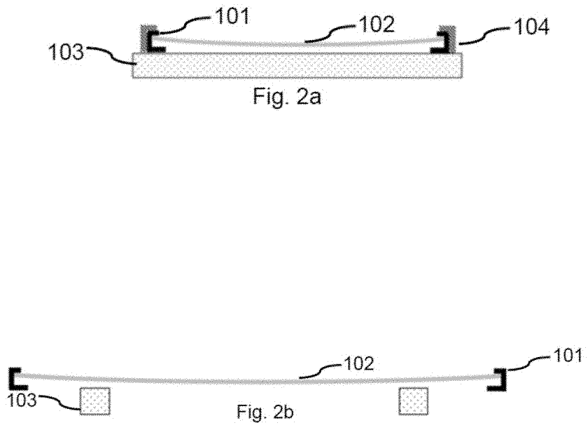

FIG. 1a shows the front side view of a solar panel with standard mounting on two rails 103 traversing the width of the panel. No load is being applied to the panel face. The extruded Al frame 101 extends around the laminate 102, where the laminate 102 includes the front coverglass, the array of solar cells, a polymer backsheet, and polymer encapsulant that fills the spaces between the glass and the backsheet. Clamps 104 press down on the top surface of the frame 101 in 4 places and secure to rails 103 to hold the panel in place. FIG. 1b shows the cross-section view of this mounted panel along the axis of one of the rails 103. FIG. 1c shows the cross-section view of this mounted panel along the axis perpendicular to the rails 103. FIG. 2a shows the cross-section view of the mounted panel along the axis of one of the rails 103 as in FIG. 1b, but in this case with a front load applied to the panel, causing it to deflect in the middle. FIG. 2b shows the cross-section view of the mounted panel along the axis perpendicular to the rails 103 as in FIG. 1c, but in this case with a front load applied to the panel, causing it to deflect in the middle.

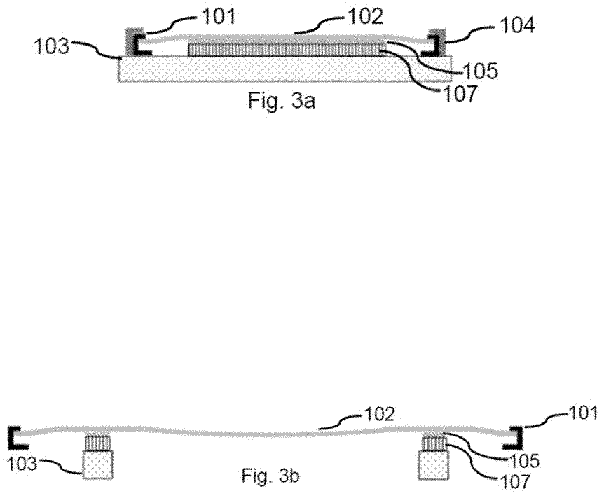

FIG. 3a shows the cross-section view of a mounted and loaded panel along the axis of one of the rails 103 as in FIG. 2a, but in this case with a RailPad assembly. The RailPad assembly may include a RailPad 107 and optionally a cushioning layer 105. Due to the RailPad assembly, the panel deflects upward near the RailPads 107. Due to the presence of the RailPads 107 across this region of the panel, minimal panel downward deflection occurs in the center. FIG. 3b shows the cross-section view of this mounted and loaded panel with RailPads 107 as in FIG. 3a but along the axis perpendicular to the rails 103.

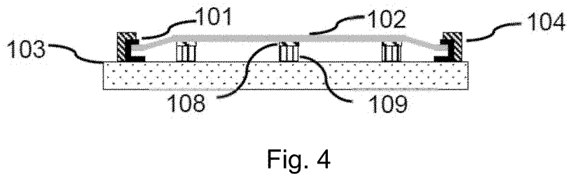

FIG. 4 shows the cross-section view of a mounted panel along the axis of one of the rails 103 as in FIG. 3c, but in this case rather than using a single long RailPad assembly, there are 3 shorter RailPad assemblies each including a RailPad 109 and optional cushioning layer 108.

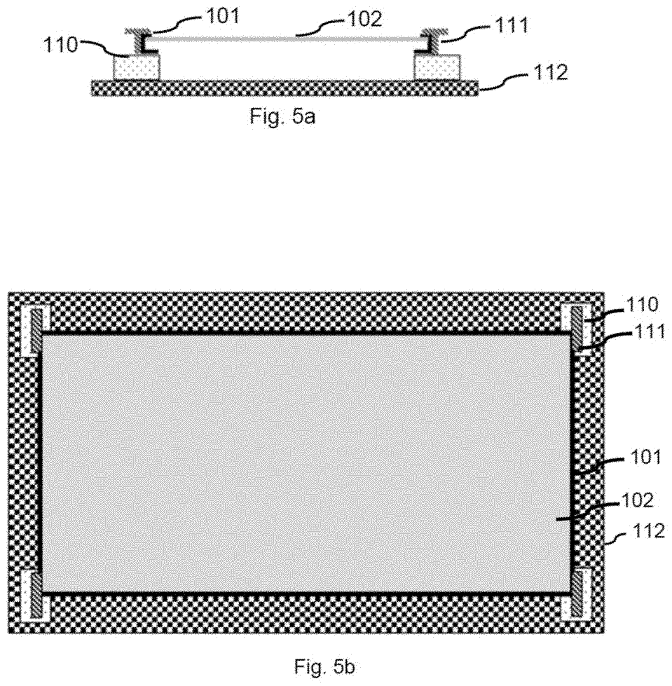

FIG. 5a shows the front side view of a solar panel with 4-point mounting on 4 short rails 110 at the corners of the panel as might be employed on a residential rooftop 112. No load is being applied to the panel face. The extruded Al frame 101 extends around the laminate 102, where the laminate 102 includes the front coverglass, the array of solar cells, a polymer backsheet, and polymer encapsulant that fills the spaces between the glass and the backsheet. Clamps 111 press down on the top surface of the frame 101 in 4 places to secure the panel to the rails 110. FIG. 5b shows the top view of the solar panel with 4-point mounting shown in FIG. 5a.

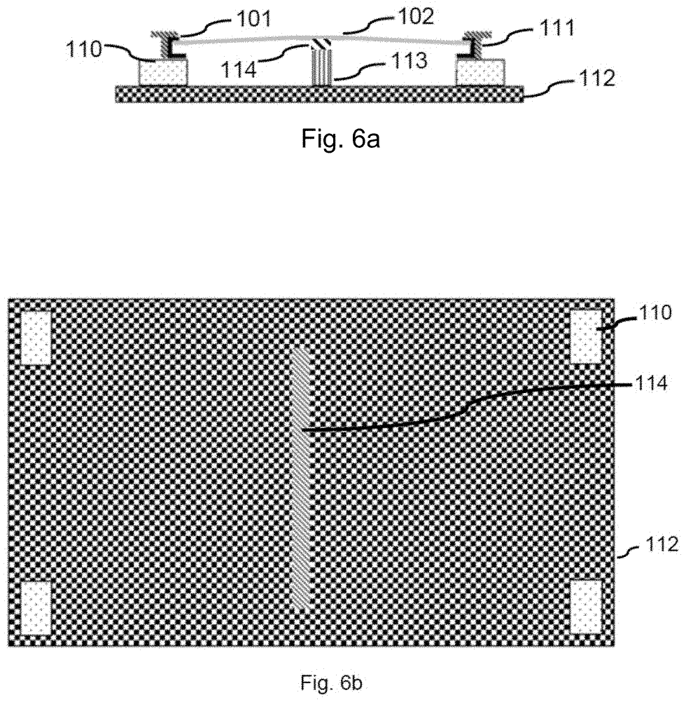

FIG. 6a shows the front side view of a solar panel with 4-point mounting on 4 short rails 110 at the corners of the panel as might be employed on a residential rooftop 112, similar to 5a except that in this case, a RoofPad 113 (also referred to as a RoofPad spacer element) in the center of the panel supports the panel to minimize deflection under load. No load is being applied to the panel face. The RoofPad spacer element 113 is illustrated in FIG. 6a including an optional top cushioning layer 114. FIG. 6b shows the top view of a rooftop 112 with 4-point mounting fixtures and a RoofPad 113 in place, as is shown in FIG. 6a, but in this case without the panel in place.

In a preferred embodiment for mounting a solar panel on flat surfaces, RoofPad spacer elements 113 have an optional top cushioning layer 114. The frame 101 of the solar panel is secured by corner clamps 111 to corner support structures 110 that are attached to the roof 112 or another flat surface. One or more RoofPad spacer elements 113 are secured to the roof 112 in order to limit deflection from front side loads. As with the RailPads, the thickness of the RoofPad spacer elements 113 can be chosen to provide outward deflection (i.e., away from (e.g., in the about normal direction out from) the rooftop 112 and/or away from (e.g., in the about normal direction out from) the rail 110) of the laminate 102 to employ the protection of compressive stress on the solar cells.

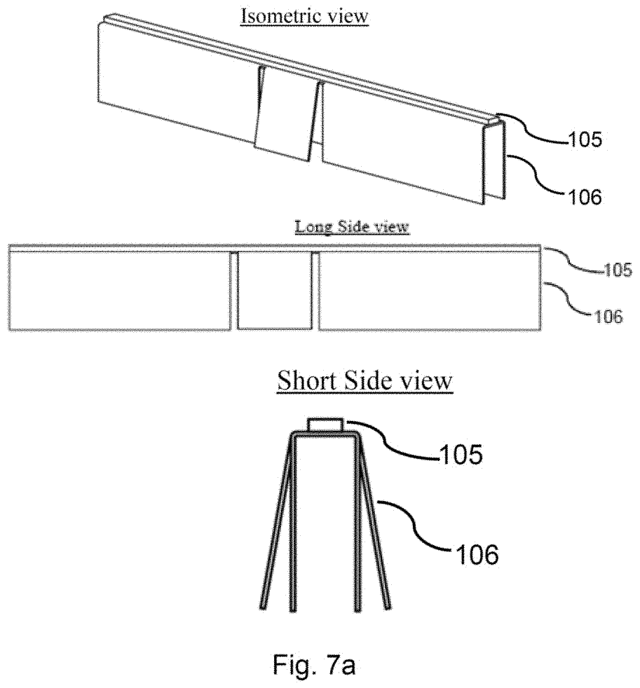

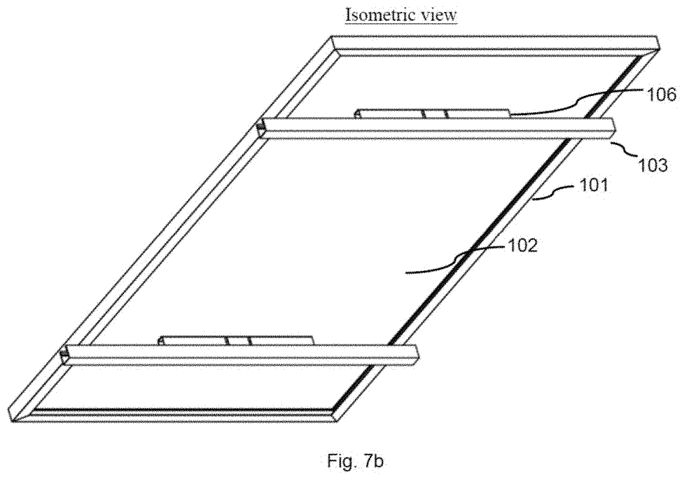

FIG. 7a shows a RailPad 106 (also referred to as a RailPad spacer element) formed from bent sheet metal and elastomer suitable for use in a new construction with a rail having wide slot. The RailPad 106 represents an example configuration of an embodiment RailPad and may be substituted for the RailPads 107 and/or 109 discussed herein. FIG. 7a shows an isometric view, long side view, and short side view of the RailPad 106 including an optional cushioning layer 105 affixed thereto. FIG. 7b shows an isometric view of the RailPad 106 from FIG. 7a after insertion into the slot of a rail 103.

In one preferred embodiment the standard solar panel consists of an extruded aluminum frame 101 that surrounds a laminate 102 that consists of glass, encapsulant, interconnected solar cells, and polymer backsheet. The solar panel is secured by metal clamps 104 to metal rails 103 that extend below the panel across either the width or length of the panel. To the rails 103 or to the back of the laminate 102 are attached RailPad spacer elements 106 that have an optional top cushioning layer 105. The total thickness of the RailPad spacer element 106 and cushioning layer 105 is chosen so that after clamping, the laminate 102 is bowed outward away from the rails 103 (i.e., away from the rooftop and/or away from the rails 103). Such outward deflection places the solar cells in a protective state of compressive stress. In one preferred variation, rather than a single long spacing element, multiple shorter RailPads 109 and surface cushioning layers 108 are used.

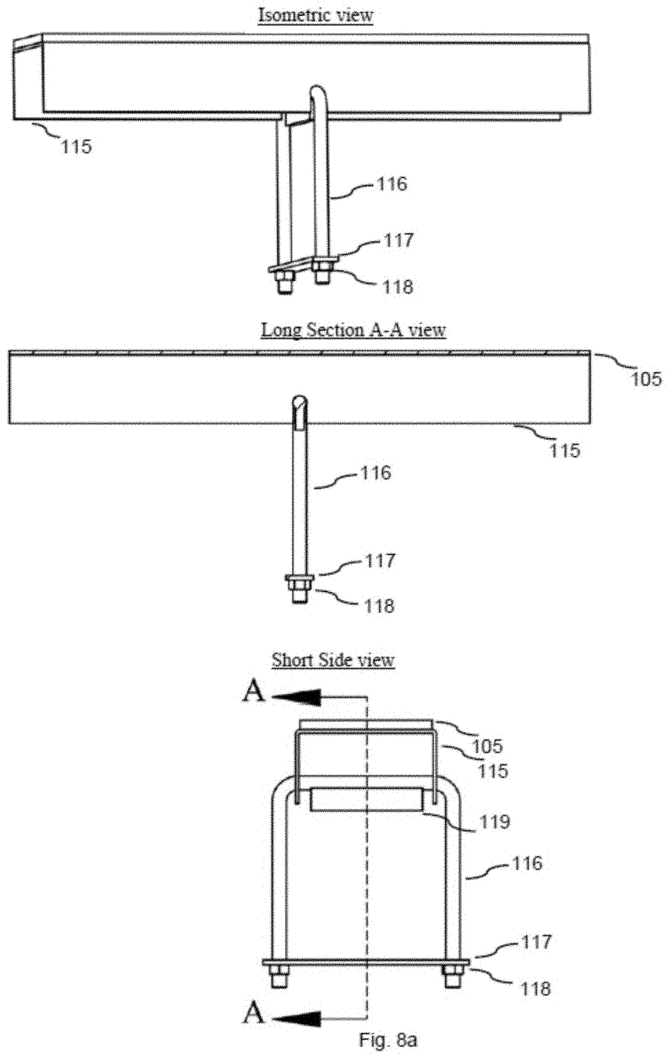

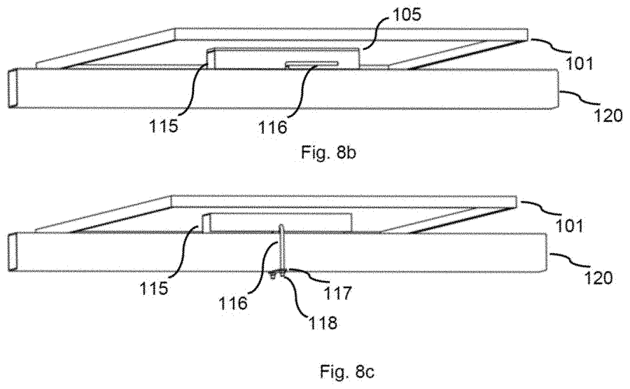

FIG. 8a shows a RailPad 115 (also referred to as a RailPad spacer element) suitable for use on a tracker system or on a ground mount system with two rails. FIG. 8b shows the RailPad 115 from FIG. 8a after insertion of the RailPad 115 between a solar panel and a rail 120 (or tracker tube). FIG. 8c shows the RailPad 115 from FIG. 8b after engagement of a cam 119 to displace the laminate 102 face away from the rail 120 and after securing of the RailPad 115 in place.

In a preferred embodiment for mounting a solar panel on a single axis tracker rail tube 120, a RailPad spacer element 115 with an optional cushioning layer 105 has a U-bolt tube clamp element 116 placed into a hole in the spacer element 115. The clamp element 116 is rotated into an upright position to allow it to be inserted between the module laminate 102 and the tracker tube 120. By then rotating the clamp element 90 degrees, a cam 119 is engaged to press against the tracker tube 120 and displace the spacer element 115 away from the tracker tube 120, thereby deflecting the laminate 102 outward (i.e., away from the rooftop) and placing the cells in compressive stress. To secure the clamp element in place, a keeper plate 117 is added to the two ends of the clamp element 116 extending out beyond the tracker tube 120, and the plate 117 is secured in place by adding nuts 118 to the threaded ends of the clamp element 116. The design allows mounting of this RailPad assembly either before or after the clamping of the solar panel to the tracker rail tube 120.

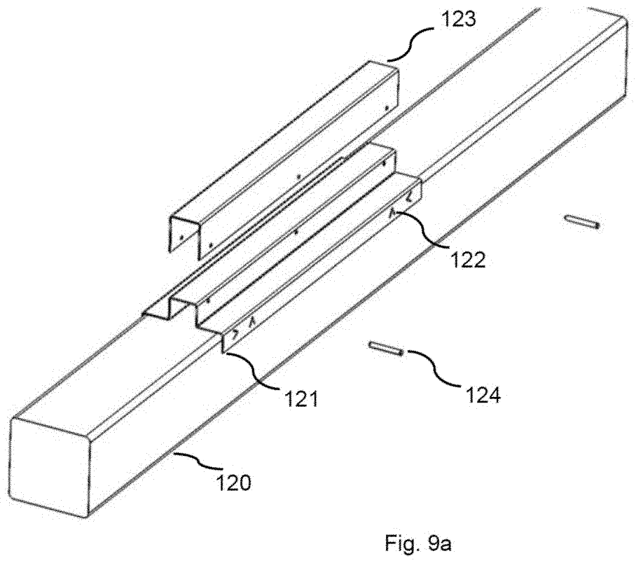

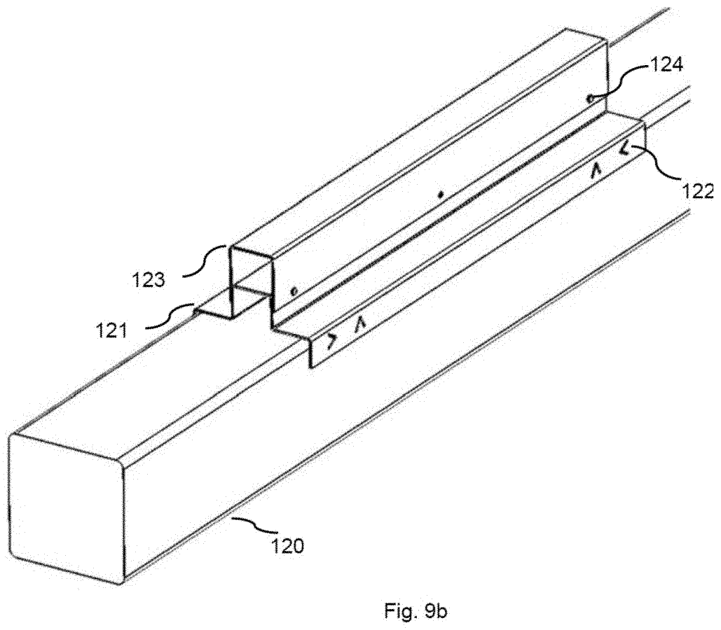

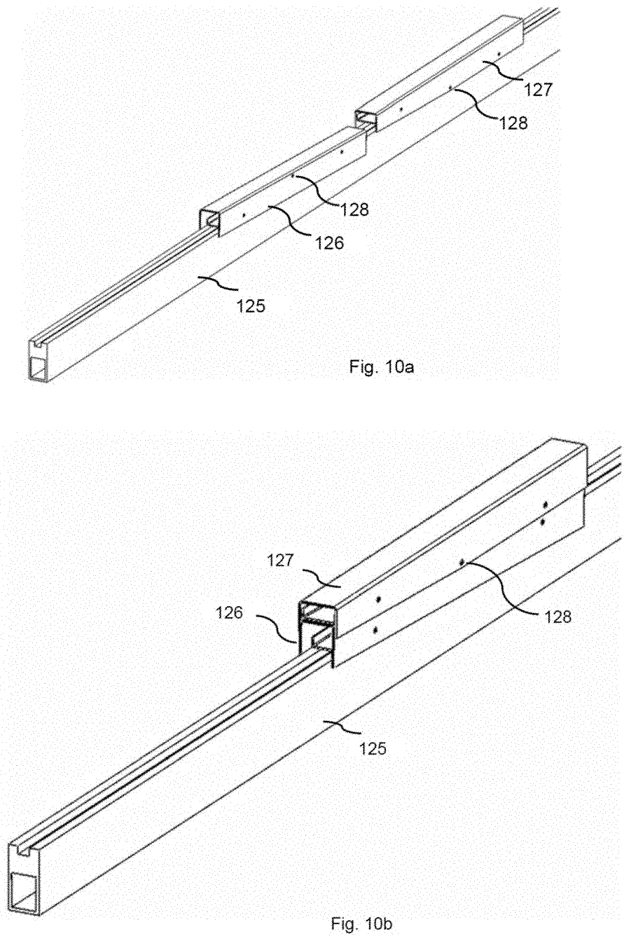

FIG. 9a shows a RailPad suitable for use on a tracker system where the bottom RailPad piece 121 (also referred to as a RailPad bottom spacer element or bottom spacer element) is first placed on the tracker rail tube 120 (or tracker rail), and a second RailPad piece 123 (also referred to a RailPad spacer top element, spacer top element, or second RailPad piece) is slid onto from the side. Alternatively, this RailPad design of FIG. 9a could be used on a ground mount system with 2 rails. FIG. 9b shows the RailPad from FIG. 9a after the laminate 102 has been lifted up to allow the second RailPad piece 123 to be raised up and secured with a pin or bolt 124.

In another preferred embodiment for mounting a solar panel on a single axis tracker rail tube 120, a RailPad spacer bottom element 121 is placed on the tracker rail tube 120 such that fixing regions 122 stamped and deformed out of the side planes of the spacer element 121 press strongly against the sides of the tracker rail tube 120 to keep the bottom spacer element 121 fixed in place. The bottom spacer element 121 height is such that it can fit in the gap between the laminate 102 and the tracker rail tube 120. A RailPad spacer top element 123 with an optional cushioning layer 105 is then slid from the side onto the spacer bottom element 121. The spacer top element 123 is the lifted away from the spacer bottom 121 to deflect the laminate 102 upward, and the spacer top element is fixed in place by inserted pins or bolts 124 into holes within the spacer elements 121 and 123.

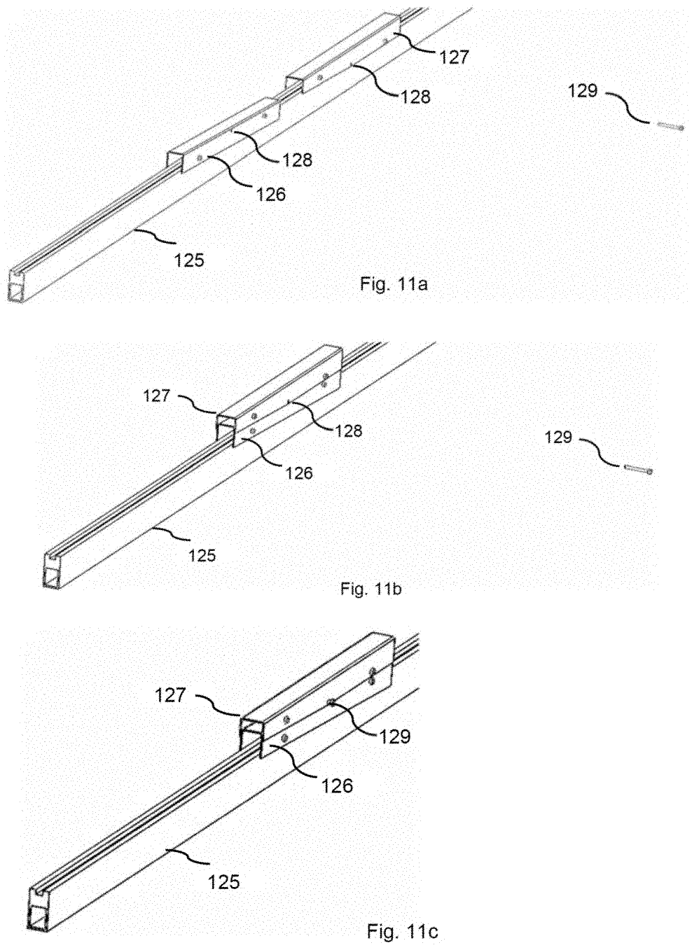

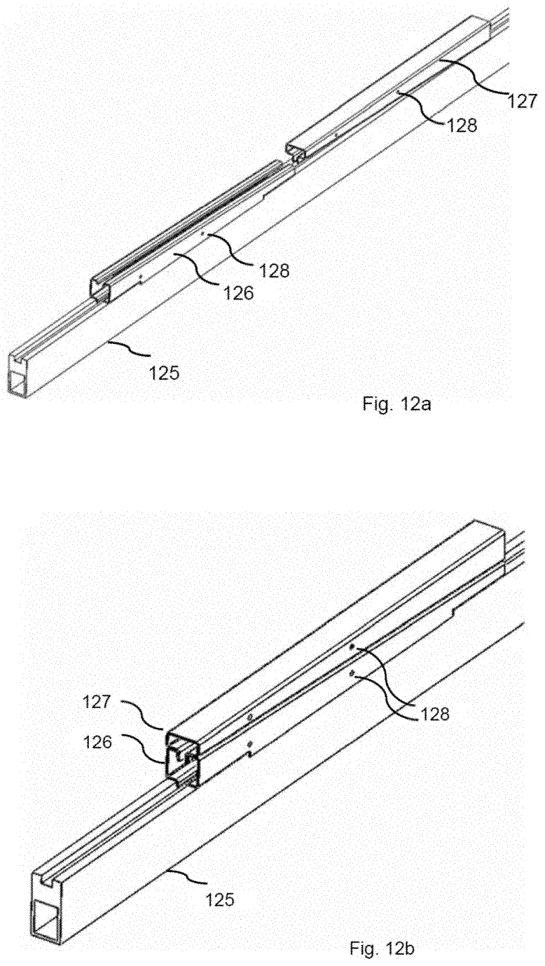

FIG. 10a shows bottom 126 and top 127 RailPad elements on a lightweight rail 125 design common in residential installations. FIG. 10b shows the RailPad elements 126, 127 from FIG. 10a after the top element 127 has been slid on top of the bottom element 126 such that the combined height is sufficient to push upward on a laminate 102. FIG. 11a shows bottom and top RailPad elements 126, 127 on a lightweight rail 125 design common in residential installations. FIG. 11b shows the RailPad elements 126, 127 from FIG. 11a after the top element 127 has been slid on top of the bottom element 126 such that the combined height is sufficient to push upward on a laminate 102. FIG. 11c shows the RailPad elements 126, 127 from FIG. 11b after a pin 129 has been inserted into holes in each element to secure them together. FIG. 12a shows bottom 126 and top 127 RailPad elements on a lightweight rail 125 design common in residential installations. The bottom element 126 is configured to engage with the center groove in the mounting rail 125, with side elements to keep it from falling off the rail. The top element 127 engages the bottom element 126, and has a feature to lock with the bottom rail 125 when it is in place. FIG. 12b shows the RailPad elements 126, 127 from FIG. 12a after the top element 127 has been slid on top of the bottom element 126 such that the combined height is sufficient to push upward on a laminate 102.

In another preferred embodiment for mounting a solar panel on rails 125, a RailPad spacer bottom element 126 with an optional cushioning layer is placed on a rail underneath an existing solar panel or underneath where a solar panel will later be placed. The bottom spacer element 126 height is such that it can fit in the gap between a laminate and the rail 125, and it has side elements to keep it from falling off the rail 125. A RailPad spacer top element 127 is then slid from the side onto the spacer bottom element 126 which causes the top element 127 to rise away from the rail 125 and deflect the laminate away from the rail 125. The top element 127 engages the bottom element 126, and has a feature to lock with the rail 125 when it is in place. Holes 128 in the elements allow the elements to be wired to the rail to prevent movement or to be joined together with the insertion of a pin or bolt 129. In some configurations, two rails 125 are used for each solar panel. The RailPad elements 126, 127 may be made from metal extrusion or stamped metal.

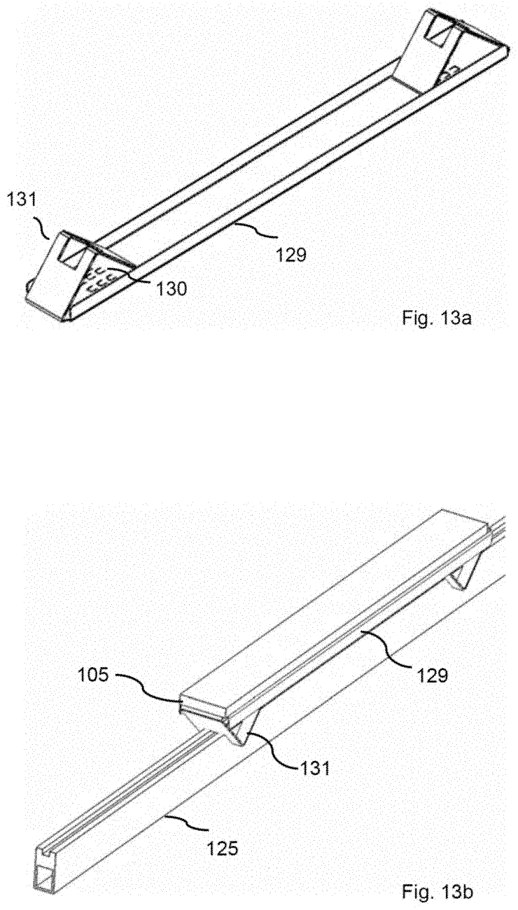

FIG. 13a shows a RailPad 129 that may be made out of a single piece of sheet metal, bent in such fashion that no extra elements are needed to install it. The RailPad 129 has sheet metal ratchet elements 130 that engage with the bent triangular elements 131, with the sheet metal being doubled for strength in certain regions. The rachet elements 130 may be all punched inwards so that the height may be adjustable in the field, or only select ones so that only a fixed height is achieved. FIG. 13b shows the RailPad 129 from FIG. 13a after it has been placed on a rail 125 and the triangular elements 131 bent so as to increase the total thickness of the RailPad 129 and cause the laminate 102 to be lifted up away from the rail 125. The 2 triangular elements 131 have been engaged with metal ratchet elements 130 to fix them in place.

In another preferred embodiment for mounting a solar panel on rails, a RailPad 129 may be made out of a single piece of sheet metal, bent in such fashion that no extra elements are needed to install it. The RailPad 129 in this embodiment has sheet metal ratchet elements 130 that engage with the bent triangular elements 131, with the sheet metal being doubled for strength in certain regions, and an optional cushioning layer 105 on top. The rachet elements 130 may be all punched inwards so that the height may be adjustable in the field, or only select ones may be punched inward so that only a fixed height is achieved

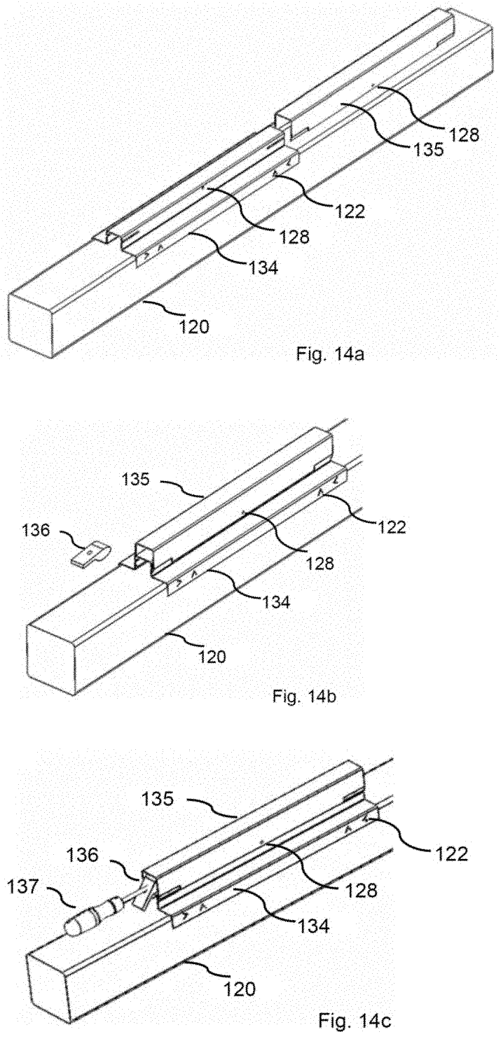

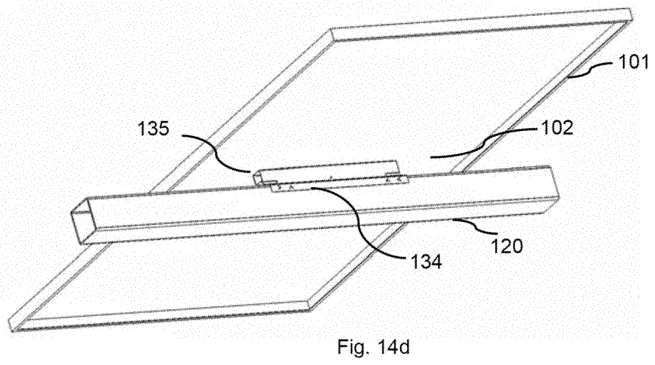

FIG. 14a shows a RailPad suitable for use on a tracker system where the RailPad bottom element 134 is first placed on the tracker rail tube 120, and a RailPad top element 135 is placed on the tube 120 to the side. FIG. 14b shows the RailPad from FIG. 14a after the RailPad top element 135 has been slid on top of the bottom element, and a cam lifting element 136 brought nearby. FIG. 14c shows the RailPad from FIG. 14c after the cam 136 has been inserted between the two RailPad elements 134, 135, and a tool 137 has rotated the cam 136 to lift the top element 135 upward to displace the laminate 102 away from the rail 120. The RailPad elements 134, 135 could then be fixed in place with a bolt or pin placed through holes 128. FIG. 14d shows the RailPad from FIG. 14c together with the module after the cam 136 action and bolt or pin fixing action are complete and the cam 136 and tool 137 removed.

In another preferred embodiment for mounting a solar panel on a single axis tracker rail tube 120, a RailPad spacer bottom element 134 is placed on the tracker rail tube 120 such that fixing regions 122 stamped and deformed out of the side planes of the spacer element 134 press strongly against the sides of the tracker rail tube 120 to keep the bottom spacer element 134 fixed in place. The bottom spacer element 134 height is such that it can fit in the gap between the laminate 102 and the tracker rail tube 120. A RailPad spacer top element 135 with an optional cushioning layer is then slid from the side onto the spacer bottom element 134. A cam 136 is then placed between the top element 135 and the bottom element 134 and rotated with a tool 137 to lift the laminate 102 upward. After fixing the spacer elements 134, 135 in place with a bolt or pin through holes 128, the cam 136 and tool 137 can be removed.

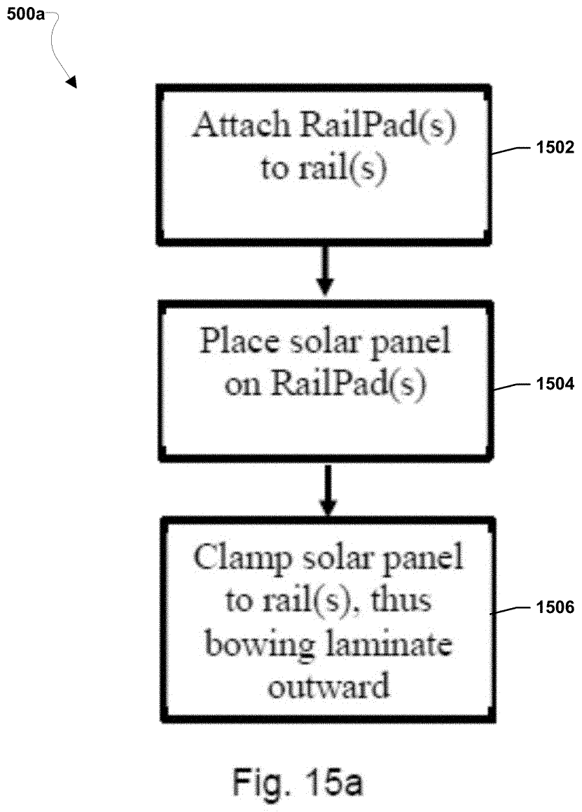

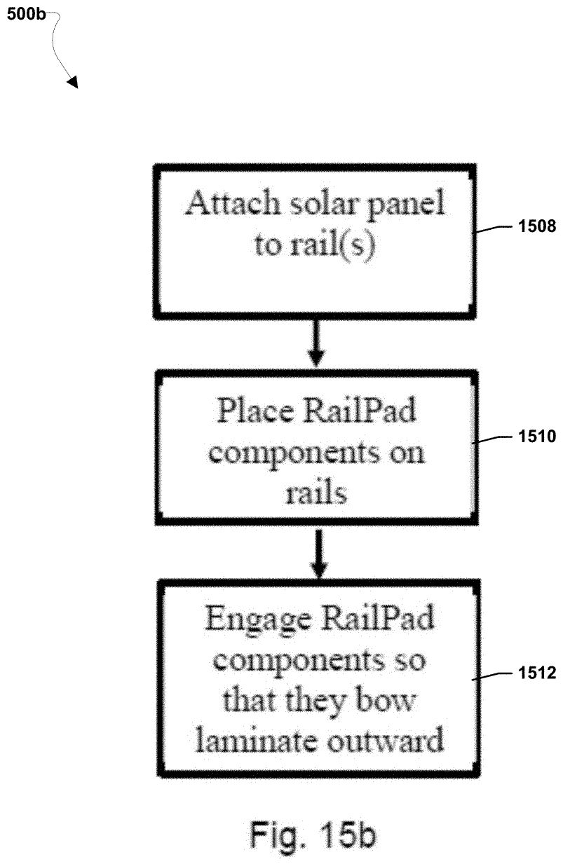

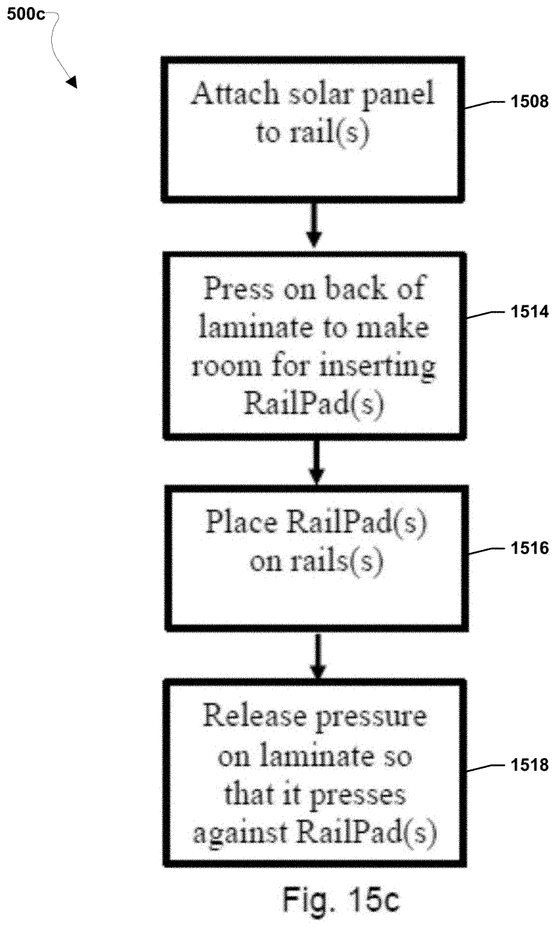

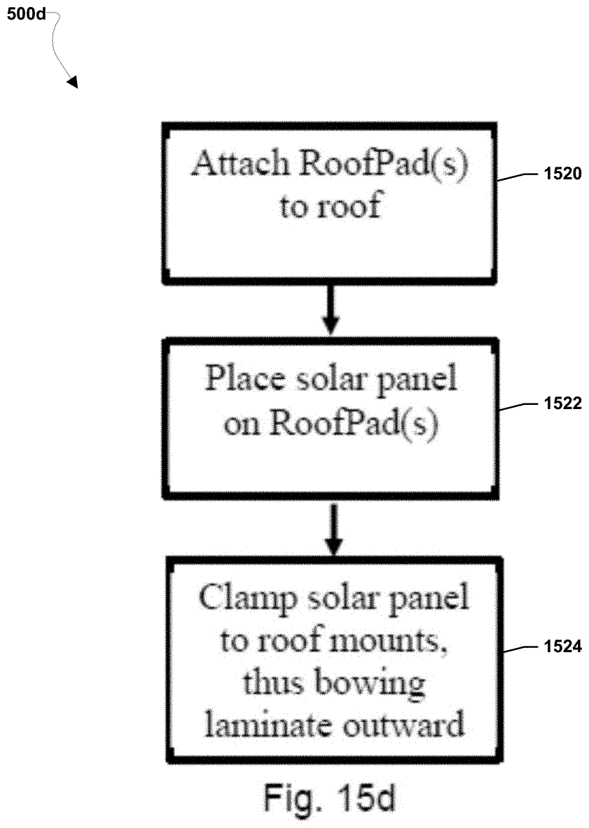

FIG. 15a illustrates an embodiment method 500a for installing RailPads in a new installation where the solar panels have not yet been mounted on the rails. The RailPads installed according to the method 500a may include any type of embodiment RailPad, such as RailPads 106, 107, 109, 106, 115, 129, the RailPads described with reference to FIGS. 11a-12b, the RailPads described with reference to FIGS. 14a-b, etc.). Step 1502 may include attaching one or more RailPads to one or more rails. Step 1504 may include placing a solar panel on the one or more RailPads. Step 1506 may include clamping the solar panel to the one or more rails, thus bowing the laminate of the solar panel outward (i.e., away from the rooftop).

FIG. 15b illustrates an embodiment method 500b for installing RailPads in a retrofit installation where the solar panels have already been mounted on the rails. The RailPads installed according to the method 500b may include any type of embodiment RailPad, such as RailPads 106, 107, 109, 106, 115, 129, the RailPads described with reference to FIGS. 11a-12b, the RailPads described with reference to FIGS. 14a-b, etc.). Step 1508 may include attaching the solar panel to one or more rails. Step 1510 may include placing RailPad components on the one or more rails. Step 1512 may include engaging the RailPad components so that they bow the laminate of the solar panel outward (i.e., away from the rooftop).

FIG. 15c illustrates an embodiment method 500c for installing RailPads in a retrofit installation where the solar panels have already been mounted on the rails. The RailPads installed according to the method 500c may include any type of embodiment RailPad, such as RailPads 106, 107, 109, 106, 115, 129, the RailPads described with reference to FIGS. 11a-12b, the RailPads described with reference to FIGS. 14a-b, etc.). As described above, step 1508 may include attaching the solar panel to one or more rails. Step 1514 may include pressing on a back of the laminate of the solar panel to make room for inserting one or more RailPads. Step 1516 may include placing one or more RailPads on the one or more rails. Step 1518 may include releasing pressure on the laminate of the solar panel so that it presses against the one or more RailPads.

FIG. 15d illustrates an embodiment method 500d for installing RoofPads in a new installation where the solar panels have not yet been mounted on the roof. The RoofPads installed according to the method 500d may include any type of embodiment RoofPad, such as RoofPad 113. Step 1520 may include attaching one or more RoofPads to a roof. Step 1522 may include placing a solar panel on the one or more RoofPads. Step 1524 may include clamping the solar panel to the roof mounts thus bowing the laminate of the solar panel outward (i.e., away from the rooftop).

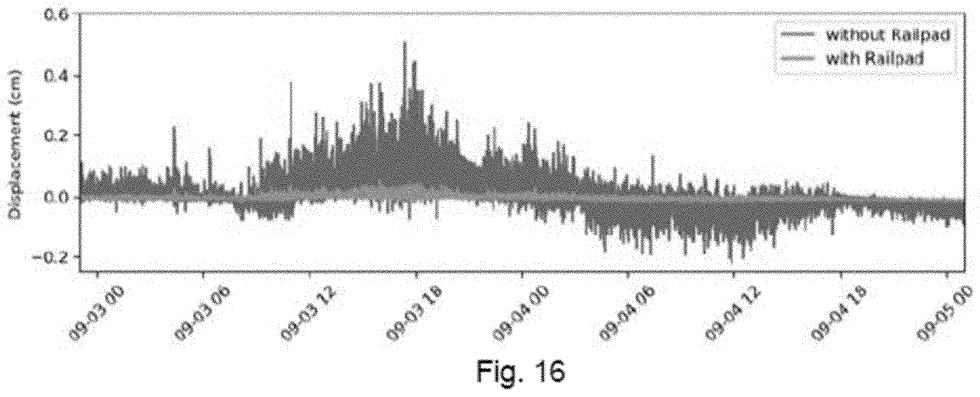

FIG. 16 shows the displacement of the center rear point of a solar panel laminate vs time during a 2019 storm in FL for both a solar panel with two RailPads and for a solar panel with no RailPads where the displacement is far less with the RailPads.

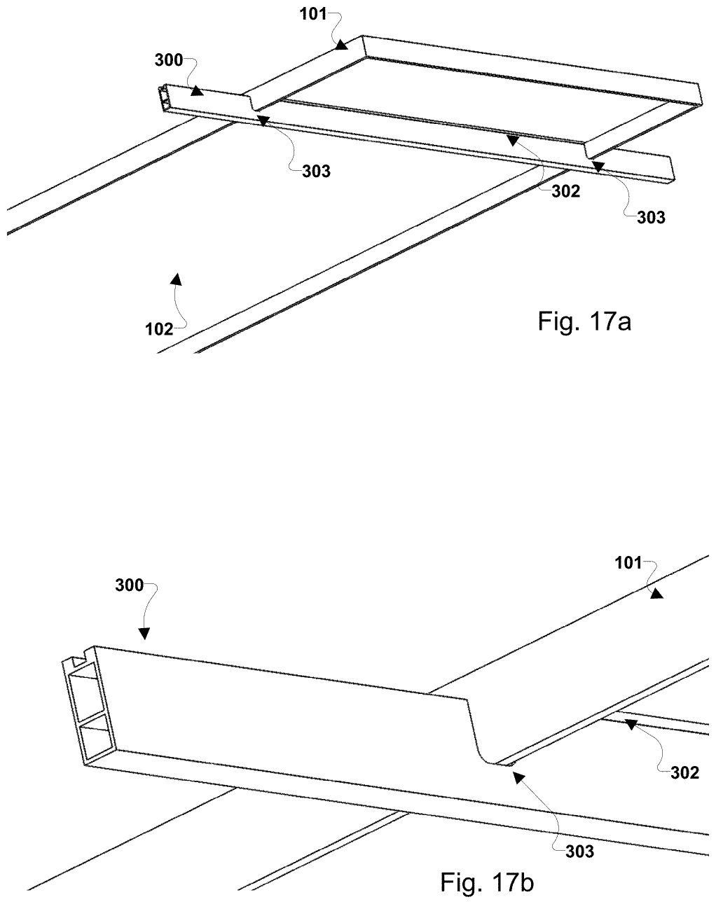

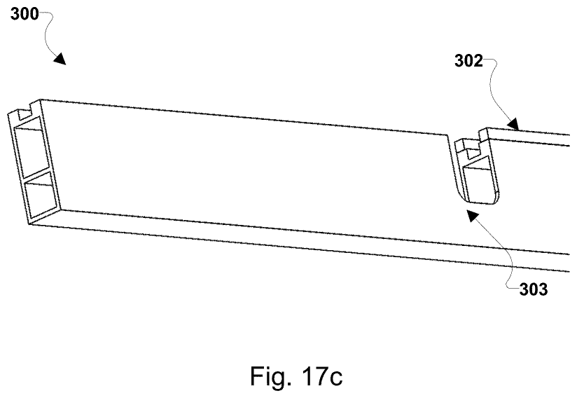

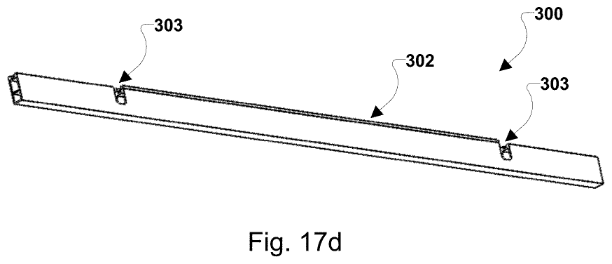

FIG. 17a shows an embodiment RailPad 302 that is an integral part of a mounting rail 300 shown with a panel mounted on the rail 300. FIG. 17b is a view of a portion of the integral RailPad 302 with panel mounted and FIG. 17c is a view of the portion of the integral RailPad 302 without the panel mounted. FIG. 17d is a view of the full RailPad 302 that is an integral part of the mounting rail 300. With reference to FIGS. 17a-17d, the mounting rail 300 may be configured as a strut that includes notches 303 formed there in and configured to receive the frame 101 of the panel. The RailPad 302 may be an integral portion of the rail 300 between the notches 303. The RailPad 302 may operate similar to the RailPads described above (such as RailPads 106, 107, 109, 106, 115, 129, the RailPads described with reference to FIGS. 11a-12b, the RailPads described with reference to FIGS. 14a-b, etc.) to bow the laminate 102 of the solar panel outward (i.e., away from the mounting structure, such as the rail 300, or the rooftop) when the panel is mounted on the rail 300. The depth of the notches 303 may be selected such that, when the frame 101 rests in the notches 303, the RailPad 302 contacts the laminate 102 to bow the laminate 102 of the solar panel outward (i.e., away from the mounting structure, such as the rail 300, or the rooftop).

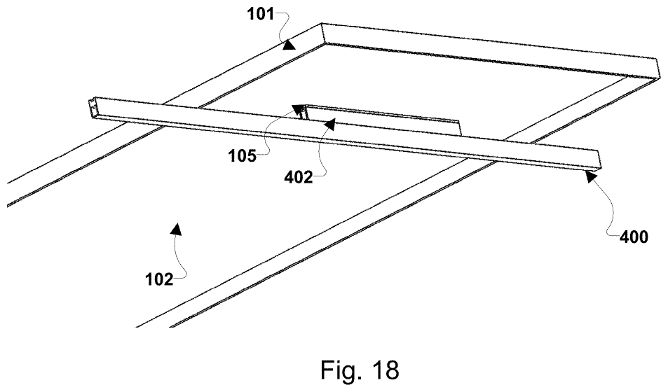

FIG. 18 shows another embodiment RailPad 402 that is an integral part of a mounting rail 400 shown with a panel mounted on the rail 400. The RailPad 402 may be a protrusion from the rail 400, such as a welded block, boss, or other type extending portion. The RailPad 402 may operate similar to the RailPads described above (such as RailPads 106, 107, 109, 106, 115, 129, the RailPads described with reference to FIGS. 11a-12b, the RailPads described with reference to FIGS. 14a-b, RailPad 302, etc.) to bow the laminate 102 of the solar panel outward (i.e., away from mounting structure, such as the rail 400, or the rooftop) when the panel is mounted on the rail 400. As illustrated in FIG. 18, the RailPad 402 may include a cushioning layer 105.

The integration of the spacer element (e.g., RailPad 302, 402) as part of the mounting rail (e.g., 300, 400) may negate a need for a separate step of inserting a spacer element between the panel and the rail after mounting the solar panel and/or a step of attaching the spacer element to the rail (e.g., step 1502) as the mounting rail (e.g., 300, 400) itself already includes the RailPad (e.g., RailPad 302, 402) as an integral portion of the mounting rail (e.g., 300, 400).

Although the primary motivation for the invention as described above relates to a reduction in silicon solar cell crack related degradation, the benefits of the invention extend to other degradation modes of silicon solar cell based solar panels and to solar panels based on other technologies, such as thin films of CIGS (Copper Indium Gallium Selenide), CdTe (Cadmium Telluride), CdSeTe (Cadmium Selenium Telluride), and perovskites. For example, introducing compressive stress and limiting tensile stress may be beneficial for interconnect wire fatigue problems, conductive adhesive contact resistivity problems, thin film adhesion problems, encapsulant and backsheet delamination problems, glass cracking problems, and edge seal integrity problems.

Various embodiments may include a photovoltaic solar panel mounting system, comprising one or more spacer elements, wherein the one or more spacer elements are configured to be positioned between a rear side of a solar panel and one or more mounting rails supporting the solar panel such that, when the one or more spacer elements are so positioned, a face of the solar panel is deflected from a neutral position away from the one or more mounting rails after two or more clamps attach the solar panel to the one or more mounting rails. In some embodiments, the one or more spacer elements may be configured to be fixed to the one or more mounting rails. In some embodiments, the one or more spacer elements may be configured to be fixed to the rear side of solar panel. In some embodiments, a distance the face of the solar panel is deflected from a neutral position may be from 0.1 to 4 centimeters (cm). In some embodiments, a distance the face of the solar panel is deflected from a neutral position may be from 0.4 to 2.5 cm. In some embodiments, the system may further comprise the one or more mounting rails, the two or more clamps, and the solar panel, wherein the solar panel has a short axis and a long axis. In some embodiments, the one or more mounting rails may be configured to run parallel to the short axis of the solar panel after the two or more clamps attach the solar panel to the one or more mounting rails. In some embodiments, the one or more mounting rails may be configured to run parallel to the long axis of the solar panel after the two or more clamps attach the solar panel to the one or more mounting rails. In some embodiments, the one or more mounting rails may be a single rail configured to operate as center tube in a tracking photovoltaic system. In some embodiments, the system may further comprise the one or more mounting rails, the two or more clamps, and the solar panel, wherein the solar panel has an axis across which the one or more mounting rails are configured to span when the one or more spacer elements are positioned between the rear side of the solar panel and the one or more mounting rails supporting the solar panel, and wherein the one or more spacer elements are configured such that a sum of lengths of the one or more spacer elements on each of the one or more mounting rails have a value between 1% and 99.9% of a length of the axis of the solar panel when the one or more spacer elements are positioned between the rear side of the solar panel and the one or more mounting rails supporting the solar panel. In some embodiments, the system may further comprise the one or more mounting rails, the two or more clamps, and the solar panel wherein the solar panel has an axis across which the one or more mounting rails are configured to span when the one or more spacer elements are positioned between the rear side of the solar panel and the one or more mounting rails supporting the solar panel, and wherein the one or more spacer elements are configured such that a sum of lengths of the one or more spacer elements on each of the one or more mounting rails have a value between 4% and 90% of a length of the axis of the solar panel when the one or more spacer elements are positioned between the rear side of the solar panel and the one or more mounting rails supporting the solar panel. In some embodiments, the one or more spacer elements are comprised of one or more of a metal, a plastic, an elastomer, a wood, a ceramic, a composite. In some embodiments, the system may further comprise a layer of elastomer material affixed to a side of each of the one or more spacer elements such that the layer of elastomer is configured to contact the rear side of the solar panel when the one or more spacer elements are positioned between the rear side of the solar panel and the one or more mounting rails supporting the solar panel. In some embodiments, the one or more spacer elements may be configured to be kept in place through pressure applied when the one or more spacer elements are positioned between the rear side of the solar panel and the one or more mounting rails supporting the solar panel without being rigidly affixed to the rear side of the solar panel or the one or more mounting rails. In some embodiments, the one or more spacer elements are an integral part of the one or more mounting rails. In some embodiments, the surface may be a rooftop surface.

Various embodiments may include a rooftop photovoltaic solar panel mounting system, comprising one or more spacer elements, wherein the one or more spacer elements are configured to be positioned between a rear side of a solar panel and a rooftop surface such that a face of the solar panel is deflected from a neutral position away from the rooftop surface after two or more clamps attach the solar panel to one or more mounting elements fixed to the rooftop surface. In some embodiments, the one or more spacer elements may be configured to be fixed to the rooftop surface. In some embodiments, the one or more the spacer elements may be configured to be fixed to the rear side of the solar panel. In some embodiments, a distance the face of the solar panel may be deflected from a neutral position may be from 0.1 to 4 cm. In some embodiments, a distance the face of the solar panel may be deflected from a neutral position may be from 0.4 to 2.5 cm. In some embodiments, the one or more spacer elements are comprised of one or more of a metal, a plastic, an elastomer, a wood, a ceramic, a composite. In some embodiments, the system may further comprise a layer of elastomer material affixed to a side of each of the one or more spacer elements such that the layer of elastomer is configured to contact the rear side of the solar panel when the one or more spacer elements are positioned between the rear side of the solar panel and the rooftop surface. In some embodiments, the one or more spacer elements may be configured to be kept in place through pressure applied when the one or more spacer elements are positioned between the rear side of the solar panel and the rooftop surface without being rigidly affixed to the rear side of the solar panel or the rooftop surface. In some embodiments, the system may further comprise the solar panel, wherein the one or more spacer elements are configured such that a sum of areas of surfaces of the one or more spacer elements contacting the rear side of the solar panel when the one or more spacer elements are positioned between the rear side of the solar panel and the rooftop surface has a value between 2% and 90% of an area of the solar panel. In some embodiments, the system may further comprise the solar panel, wherein the one or more spacer elements are configured such that a sum of areas of surfaces of the one or more spacer elements contacting the rear side of the solar panel when the one or more spacer elements are positioned between the rear side of the solar panel and the rooftop surface has a value between 5% and 50% of an area of the solar panel.

Various embodiments may include a method for mounting a photovoltaic solar panel, the method comprising positioning one or more spacer elements between a rear side of a solar panel and a mounting surface such that a face of the solar panel is deflected from a neutral position in a direction outward from the mounting surface after attachment of the solar panel to the mounting surface. In some embodiments, the mounting surface comprises one or more rails. In some embodiments, the mounting surface comprises a rooftop. In some embodiments, the method may further include attaching the solar panel to the mounting surface after the positioning of the one or more spacer elements between the rear side of the solar panel and the mounting surface. In some embodiments, the method may further include attaching the solar panel to the mounting surface before the positioning of the one or more spacer elements between the rear side of the solar panel and the mounting surface. In some embodiments, the positioning the one or more spacer elements between the mounting surface and the rear side of the solar panel causes the face of the solar panel to be deflected outward. In some embodiments, the method may further include applying pressure to the rear side of the solar panel prior to positioning the one or more spacer elements between the rear side of the solar panel and the mounting surface, and releasing the pressure to the rear side of the solar panel after positioning the one or more spacer elements between the rear side of the solar panel and the mounting surface thereby causing the rear side of the solar panel to contact the one or more spacer elements.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the claims are not intended to be limited to the aspects described herein but are to be accorded the widest scope consistent with the following claims and the principles and novel features disclosed herein.

What is claimed is:

1. A photovoltaic solar panel mounting system, comprising:
one or more spacer elements, wherein the one or more spacer elements are configured to be positioned between a rear side of a solar panel and one or more mounting rails supporting the solar panel such that, when the one or more spacer elements are so positioned, a face of the solar panel is deflected from a neutral position away from the one or more mounting rails after two or more clamps attach the solar panel to the one or more mounting rails.

2. The mounting system of claim 1, wherein the one or more spacer elements are configured to be fixed to the one or more mounting rails.

3. The mounting system of claim 1, wherein the one or more spacer elements are configured to be fixed to the rear side of solar panel.

4. The mounting system of claim 1, wherein a distance the face of the solar panel is deflected from a neutral position is from 0.1 to 4 cm.

5. The mounting system of claim 1, wherein a distance the face of the solar panel is deflected from a neutral position is from 0.4 to 2.5 cm.

6. The mounting system of claim 1, further comprising:
the one or more mounting rails;
the two or more clamps; and
the solar panel, wherein the solar panel has a short axis and a long axis.

7. The mounting system of claim 6, wherein the one or more mounting rails are configured to run parallel to the short axis of the solar panel after the two or more clamps attach the solar panel to the one or more mounting rails.

8. The mounting system of claim 6, wherein the one or more mounting rails are configured to run parallel to the long axis of the solar panel after the two or more clamps attach the solar panel to the one or more mounting rails.

9. The mounting system of claim 6, wherein the one or more mounting rails are a single rail configured to operate as center tube in a tracking photovoltaic system.

10. The mounting system of claim 1, further comprising:
the one or more mounting rails;
the two or more clamps; and
the solar panel,
wherein the solar panel has an axis across which the one or more mounting rails are configured to span when the one or more spacer elements are positioned between the rear side of the solar panel and the one or more mounting rails supporting the solar panel, and
wherein the one or more spacer elements are configured such that a sum of lengths of the one or more spacer elements on each of the one or more mounting rails have a value between 1% and 99.9% of a length of the axis of the solar panel when the one or more spacer elements are positioned between the rear side of the solar panel and the one or more mounting rails supporting the solar panel.

11. The mounting system of claim 1, further comprising:
the one or more mounting rails;
the two or more clamps; and
the solar panel,
wherein the solar panel has an axis across which the one or more mounting rails are configured to span when the one or more spacer elements are positioned between the rear side of the solar panel and the one or more mounting rails supporting the solar panel, and
wherein the one or more spacer elements are configured such that a sum of lengths of the one or more spacer elements on each of the one or more mounting rails have a value between 4% and 90% of a length of the axis of the solar panel when the one or more spacer elements are positioned between the rear side of the solar panel and the one or more mounting rails supporting the solar panel.

12. The mounting system of claim 1, wherein the one or more spacer elements are comprised of one or more of a metal, a plastic, an elastomer, a wood, a ceramic, a composite.

13. The mounting system of claim 1, further comprising a layer of elastomer material affixed to a side of each of the one or more spacer elements such that the layer of elastomer is configured to contact the rear side of the solar panel when the one or more spacer elements are positioned between the rear side of the solar panel and the one or more mounting rails supporting the solar panel.

14. The mounting system of claim 1, wherein the one or more spacer elements are configured to be kept in place through pressure applied when the one or more spacer elements are positioned between the rear side of the solar panel and the one or more mounting rails supporting the solar panel without being rigidly affixed to the rear side of the solar panel or the one or more mounting rails.

15. The mounting system of claim 1 where the one or more spacer elements are an integral part of the one or more mounting rails.

16. A rooftop photovoltaic solar panel mounting system, comprising:
one or more spacer elements, wherein the one or more spacer elements are configured to be positioned between a rear side of a solar panel and a rooftop surface such that a face of the solar panel is deflected from a neutral position away from the rooftop surface after two or more clamps attach the solar panel to one or more mounting elements fixed to the rooftop surface.

17. The mounting system of claim 16, wherein the one or more spacer elements are configured to be fixed to the rooftop surface.

18. The mounting system of claim 16, wherein the one or more the spacer elements are configured to be fixed to the rear side of the solar panel.

19. The mounting system of claim 16, wherein a distance the face of the solar panel is deflected from a neutral position is from 0.1 to 4 cm.

20. The mounting system of claim 16, wherein a distance the face of the solar panel is deflected from a neutral position is from 0.4 to 2.5 cm.

21. The mounting system of claim 16, wherein the one or more spacer elements are comprised of one or more of a metal, a plastic, an elastomer, a wood, a ceramic, a composite.

22. The mounting system of claim 16, further comprising a layer of elastomer material affixed to a side of each of the one or more spacer elements such that the layer of elastomer is configured to contact the rear side of the solar panel when the one or more spacer elements are positioned between the rear side of the solar panel and the rooftop surface.

23. The mounting system of claim 16, wherein the one or more spacer elements are configured to be kept in place through pressure applied when the one or more spacer elements are positioned between the rear side of the solar panel and the rooftop surface without being rigidly affixed to the rear side of the solar panel or the rooftop surface.

24. The mounting system of claim 16, further comprising the solar panel, wherein the one or more spacer elements are configured such that a sum of areas of surfaces of the one or more spacer elements contacting the rear side of the solar panel when the one or more spacer elements are positioned between the rear side of the solar panel and the rooftop surface has a value between 2% and 90% of an area of the solar panel.

25. The mounting system of claim 16, further comprising the solar panel, wherein the one or more spacer elements are configured such that a sum of areas of surfaces of the one or more spacer elements contacting the rear side of the solar panel when the one or more spacer elements are positioned between the rear side of the solar panel and the rooftop surface has a value between 5% and 50% of an area of the solar panel.

26. A method for mounting a photovoltaic solar panel, the method comprising:
positioning one or more spacer elements between a rear side of a solar panel and a mounting surface such that a face of the solar panel is deflected from a neutral position in a direction outward from the mounting surface after attachment of the solar panel to the mounting surface.

27. The method of claim 26, wherein the mounting surface comprises one or more rails.

28. The method of claim 26, wherein the mounting surface comprises a rooftop.

29. The method of claim 26, further comprising attaching the solar panel to the mounting surface after the positioning of the one or more spacer elements between the rear side of the solar panel and the mounting surface.

30. The method of claim 26, further comprising attaching the solar panel to the mounting surface before the positioning of the one or more spacer elements between the rear side of the solar panel and the mounting surface.

31. The method of claim 26, wherein the positioning the one or more spacer elements between the mounting surface and the rear side of the solar panel causes the face of the solar panel to be deflected outward. 32 The method of claim 26, further comprising:
applying pressure to the rear side of the solar panel prior to positioning the one or more spacer elements between the rear side of the solar panel and the mounting surface; and
releasing the pressure to the rear side of the solar panel after positioning the one or more spacer elements between the rear side of the solar panel and the mounting surface thereby causing the rear side of the solar panel to contact the one or more spacer elements.
